(19) United States
(12) Patent Application Publication
(10) Pub. No.: US 2006/0256730 A1
(43) Pub. Date: Nov. 16, 2006

(54) Intelligent quarantine device

(76) Inventor: Richard A. Compton, Rock Hill, MO (US)

Correspondence Address: Ronald N. Compton;Summers, Compton, Wells & Hamburg, P.C., 8909 Ladue Road, St. Louis, MO, 63124, US

(21) Appl. No.: 11/127,353

(22) Filed: May 12, 2005

(51) Int. Cl. H04J 1/16

(52) U.S. Cl. 370/250

(57) ABSTRACT

A process or device in a network to identify anomalous traffic, identifying the host which is the source of the anomalous traffic and then isolating the offending host to a second or virtual network to prevent infection of other hosts by the offending device; remediation of the offending host and reinsertion into the network of the remediated host.

### FIELD OF THE INVENTION

The present invention relates generally to a network quarantine device which identifies anomalies network traffic, isolates the offending device generating the anomaly to prevent proliferation, remediates offending devices and reinserts the disinfected host into the network.

### BACKGROUND OF THE INVENTION

Currently there is a major problem with networks comprised of hosts which are structured to communicate with other hosts on the same network as well as other networks and hosts throughout the world. In addition to communicating information and data which is desired there are a plethora of undesirable viruses or other malware also inadvertently communicated to hosts. The infection may come from many sources. A firewall may be inadequate to stop the latest exploit or virus or an e-mailed birthday e-card that may have an associated virus which infects the host when the e-card is displayed. A laptop may be brought from work, taken home and then connected to the internet where it is infected with a virus. The laptop is then brought to work and infects all of the other hosts even though those hosts are behind a “secure” firewall. The alternative to this is to completely prohibit all contact with others. The network is then completely secure and also unusable. Thus, it is impossible to have a network which is both open to practical use and still is completely protected against infection. Various companies providing devices to networks have developed products which partially address this problem. There are IDS's (Intrusion Detection Systems) and IPS's (Intrusion Prevention Systems) available which detect and in the case of an IPS, block potentially malicious traffic. However, they do nothing to quarantine or remediate infected hosts.

There are applications such as Citadel's Hercules which will remotely install updated versions of software but there is no product which will install software on hosts based on IDS/IPS alerts. Cisco Systems has created an updated Internet Operation Software (IOS) for their network devices which interoperates with antivirus software to block network access to a device which does not have the current virus protection software version installed on it. This however is inwardly directed to the host only and does not dynamically monitor threats to a host and if it becomes infected, remove it from the main network “N” and move it to a closed quarantined network “Q” and then remediate it based upon IDS/IPS alerts, finally reinserting the remediated host back into “N”.

Networks are required by most companies to conduct business. A greater percentage of business is conducted electronically rather than through the mail or a facsimile every day. Smaller companies can't afford the substantial cost of hiring and keeping continuously trained a dedicated network administration staff twenty-four hours a day seven days a week. When a virus affects a number of computers (hosts) on a network it is most often required that a technician visit each computer personally to remove a virus, recover corrupted data and to make the computer useable again. By the time this is done, the originally infected computer may have retransmitted the infected code to hundreds or thousands of other computers thus multiplying the task of remediation a thousand fold. Medium and small size companies can't afford this staff but have the same needs and vulnerabilities since in one sense, the internet is one big network and all companies, big and small, are a part of it. A device which could serve as the immune system of a network to dynamically in real time identify infections, quarantine infected hosts, and automatically, repair infected computers placing them back on the network all without any knowledge or intervention by a network administrator is in great need regardless of the size of the enterprise.

A part from IDS/IPS monitoring, another network administration task in today's world is the need to have proper software rights in each user along with the required version of each program operating on a host. Many individuals will not perform this “housekeeping” no matter how often the e-mail directing the user to upgrade is sent from the IT staff. These recalcitrant users could also be detected and isolated in the “Q” quarantine network until they heeded the upgrade requirement. By “spoofing” DNS lookups and IP traffic, any network query would display a message to the user that he or she was “quarantined” until the required upgrade had been performed.

Another function of the invention is to provide a framework which is suitable for input generically from many vendors' existing switches or IDS's, IPS's and other network devices.

Accordingly I have invented the IQ or Intelligent Quarantine device, the preferred embodiment of which is described below.

The IQ can communicate with multiple vendor/multiple security devices such as IDS, IPS or a Vulnerability Assessment Device that can send a message to a switch or other network device to place the host into an isolated network. This will only permit the selected host to communicate within a predefined narrow virtual space or the “Quarantined” network.

FIRST: There is a network “N”.

SECOND: There is a virtual network inside the network switch or a VLAN (Virtual Local Area Network) or any other means of segregating network traffic.

THIRD: There is a communication from an intrusion detection system (IDS) (or other Network Administrator selected criteria) to enable identification of an anomalous host.

FOURTH: Once the anomalous host is identified, the anomalous host is placed in a Quarantine VLAN and any future inquiries from the anomalous host are redirected to force the anomalous host to a remediation server in the VLAN no matter what address is attempted by the offending host.

FIFTH: The Quarantine VLAN is configured so that the anomalous host placed into this network can only communicate with the IQ device and any other devices restricted to the VLAN. The IQ device is the only device which can communicate with the working network and the Quarantine VLAN.

Thus, there is a need for a device or system that overcomes the foregoing and other shortcomings. The present invention fulfills this and other needs.

### SUMMARY OF THE INVENTION

In accordance with one aspect of the present invention, this is a new device which can continuously communicate with multiple vendor security and networking devices such as intrusion detection devices and switches in real time to identify anomalous network traffic and then to automatically isolate and quarantine any host from the main network “N” to a closed “Q” or quarantine network. Once isolated from the main network “N” the host that generated the anomalous traffic may no longer communicate to any other host wherever located on “N”. It is another object of this invention that once a host that generated the anomalous traffic is isolated to the “Q” quarantine network for the device to apply a known fix to remediate the host and then once remediated, reinsert the host into “N” the working network.

The above summary of the present invention is not intended to represent each embodiment, or every aspect, of the present invention. Additional features and benefits of the present invention will become apparent from the detailed description, figures, and claims set forth below.

### BRIEF DESCRIPTION OF THE DRAWINGS

The foregoing and other advantages of the invention will become apparent upon reading the following detailed description and upon reference to the drawings.

FIG. 1 shows a block diagram of the communications with the IQ device to move an anomalous host to/from the working network to the quarantine network.

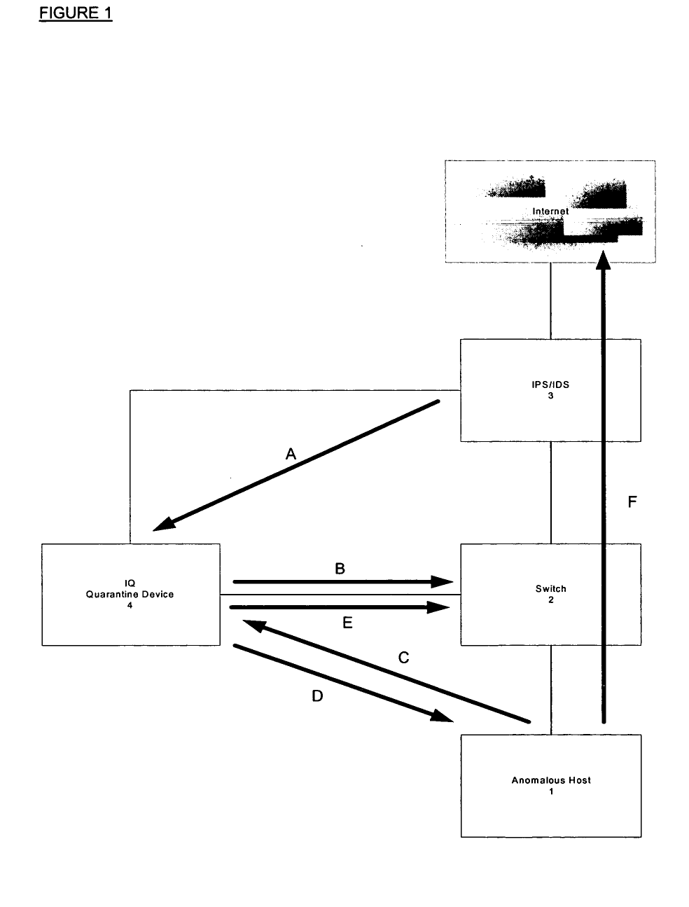

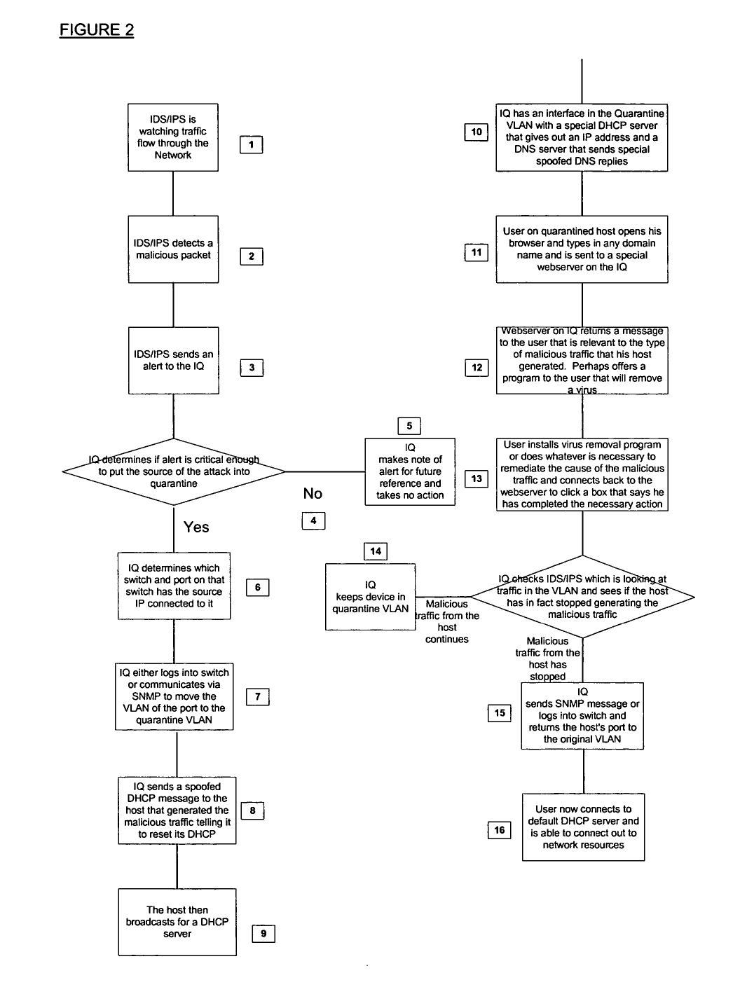

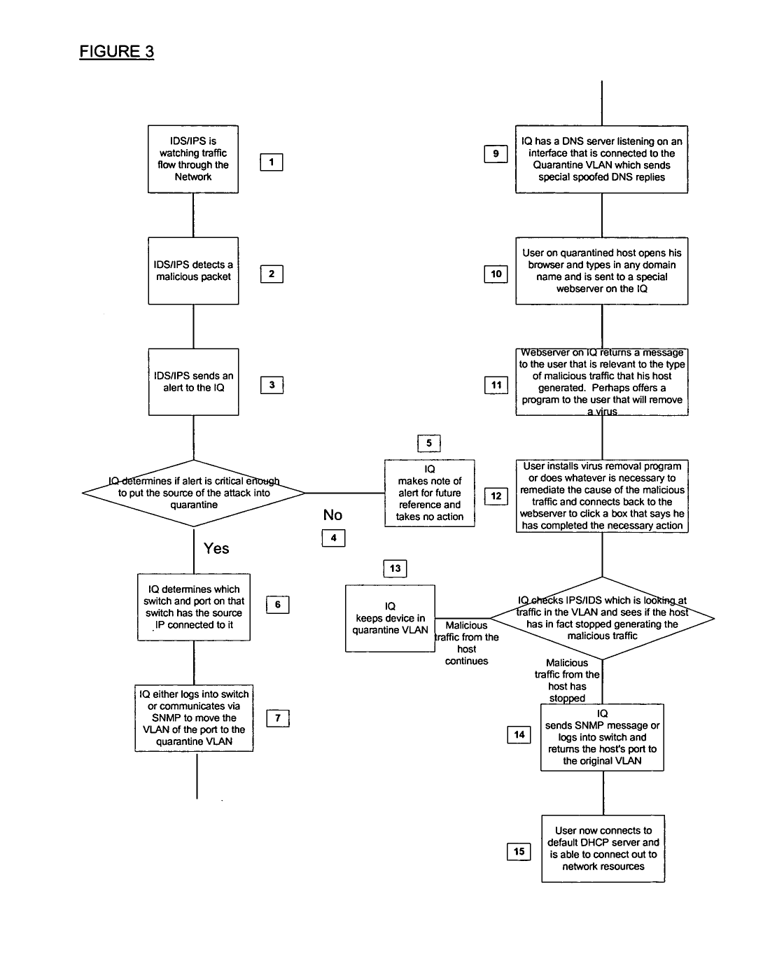

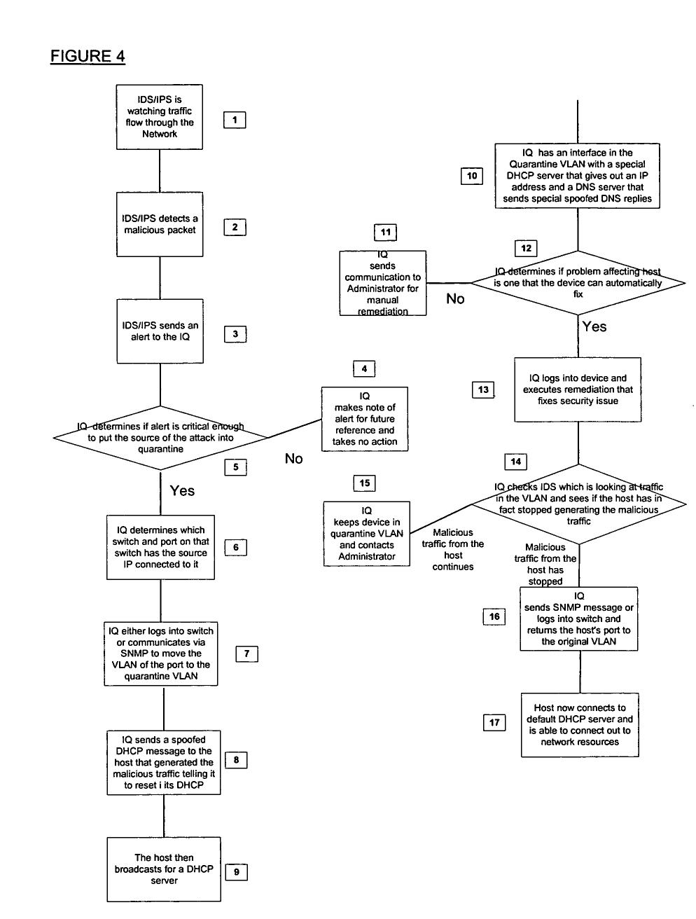

In FIG. 1: The anomalous host (1) is connected via a network to switch (2) which would be a standard network switch, interconnecting two or more host computers or other devices to a network through path (B, E). The switch (7) also connects to the intrusion prevention system/intrusion detection system (IPS/IDS) (3). Typical examples of an IPS/IDS are Snort, TippingPoint IPS and ISS Proventia. The IPS/IDS (3) is, in this example, in turn connected to the outside world via the Internet. Normal network traffic (F) would flow from the host (1) through the switch (2), through the IPS (3) to the Internet or in the case of an IDS passively monitoring the traffic as it flows to the Internet.

FIG. 1 shows an anomalous host (1) having characteristics which are not desired to exist on the network either as a computer virus or other self-replicating anomaly, or any other conditions such as a software version not compatible or permitted by the network administrator. In the case of a virus or self-replicating anomaly producing anomalous network traffic, the anomaly network traffic would travel from anomalous host (1) by Path F through switch (2) to the IPS/IDS (3). The IPS/IDS (3) would detect and (in the case of an IPS) block malicious network traffic, notifying the quarantine/remediation device.

The network device (2) has a minimum of two networks: the working network and a quarantine network, which is predefined in order to contain quarantined hosts. The network device could be a layer 2 or layer 3 switch with VLAN capabilities. Examples of this device are Cisco 6509, Cisco 3550, Foundry Big Iron. The IPS/IDS (3) detects anomalous behavior from anomalous host (1) and sends a message to the quarantine/remediation device (IQ) (4). The quarantine/remediation device (4) logs into switch (2) and reconfigures the port of the switch (2) which serves the anomalous host (1) to direct all network traffic to a separate virtual local area network (VLAN). All anomalous host (1) traffic is then redirected to the IQ (4) because the port on the switch (2) to which anomalous host (1) is connected has been changed to redirect the anomalous host (1) traffic to the quarantine VLAN, thus removing the anomalous host from the primary network and forcing it to quarantine isolation where the anomalous host (1) believes it is communicating with its requested destination switch (2), but in fact all of its network traffic has been redirected through Path C to the quarantine/remediation device (4). Thus, having been removed from the network, the anomalous host's network traffic is prevented from infecting other hosts on the working network and others through the Internet.

The IQ device (4) will then perform remediation on the anomalous host (1) by removing or disabling the offending virus or anomaly or otherwise correcting the anomalies' characteristics through Path D. It will optionally test the anomalous host and verify that the remediation has correctly occurred. The IQ (4) then logs into switch (2) and through Path E reconfigures the port of the switch to allow the previous anomalous host to communicate with the original working network, along with the other compliant hosts.

FIG. 2 is a flow chart which shows the same process as in FIG. 1, not on a device basis but on a network traffic basis. FIG. 2 shows the process flow of the remediation of an infected host.

(1) The IDS/IPS monitors traffic flow through the working network.

(2) The IDS/IPS detects a malicious packet which is emanating from an anomalous host.

(3) The IDS/IPS sends an alert to the IQ device.

(4) The IQ determines, according to programmable parameters, if the alert is sufficiently critical to put the source of the attack into quarantine.

(5) If the alert is not sufficiently critical, then the IQ simply makes note of the alert for future reference in a log and takes no action.

(6) If it is sufficiently critical to quarantine the anomalous host, then the IQ (6) determines which switch and port on that switch has the source IP of the host connected to it.

(7) The IQ either logs into the switch or communicates via SNMP to move the virtual local area network of the port to the quarantine virtual local area network (7).

(8) The IQ has a spoofing mechanism which could be a domain name server (a DNS server) listening on an interface that is connected to the quarantine remedial VLAN which sends special spoofed domain name service replies, or DNS replies. Thus, spoofing the host into thinking that it remains connected to the working VLAN on the switch. The IQ sends special spoofed DNS replies to the quarantine host. A user on a quarantine host would open his browser and type in any domain name and whatever request was sent would be redirected to a special webserver on the IQ. This can also be accomplished on a lower protocol level by spoofing an entire IP network on the IQ as is possible with open source tools such as Honeyd.

(9) The webserver on the IQ device returns a message to the user on the anomalous host.

(10) The webserver on the IQ device returns a message to the user that is relevant to the type of malicious traffic that the host generated, perhaps offer a program to the user that will remove a virus or upgrade a program, whatever is appropriate.

(11) The user then installs the virus removal program or does whatever is necessary to remediate the cause of the malicious traffic. The IQ would check to ensure that malicious traffic from the host is stopped or that the appropriate upgrade has been completed.

(12) If the malicious traffic from the host continues, the IQ would keep the device in the quarantine VLAN.

(13) If the malicious traffic has stopped or if the upgrade has been completed, the IQ sends an SNMP message or logs into the switch and

(14) Returns the host port to the original working local area network.

(15) The user of the anomalous host which has now been corrected connects to the working network and is able to connect out to network resources.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

FIG. 3 shows an original local area network (LAN) and a virtual LAN. There is an anomalous host which produces anomalous network traffic, that is traffic which does not meet desired criteria. The quarantine/remediation device is simply a host device on the physical network with privileges and rights to:
communicate with the Intrusion Protection System to receive notification and identification of anomalous behavior
communicate with the switch or other network device
have the privileges and rights to reconfigure the switch or other network device
transfer an anomalous host in and out of the normal network to the virtual network

The concept relies upon the use of a virtual network and spoofing or faking of the destination addresses to which the anomalous host would normally connect and send its IP traffic. The anomalous host believes that it is still connected to the primary network VLAN when in fact it has been diverted to the quarantine VLAN, thus isolating it and preventing it from communicating with any other host or the Internet. Typically, the host would be a personal computer running Microsoft Windows XP Professional, Microsoft 2000 Professional, Linux or some other operating system on a TCP/IP Network. The anomalous host need not be a computer but could be any computational entity which processes data and communicates with a network.

In this case (FIG. 3) the user of an anomalous host who attempts to use a web browser is redirected to a quarantine network (7) webserver which requires remediation of the anomalous host as for example to run a program which will remove a virus or upgrade a version of software or any other remediation conduct from the anomalous host user (11, 12). After the remediation occurs (13), the previous anomalous host's port is reset to again communicate directly with the default network (15) virtual local area network and the default DHCP (16).

FIG. 4 is similar to FIG. 3 except that this flow design is for a process which does not require the input of the user of the infected host but rather performs the remediation automatically (13) if possible (12) or alerts a network administrator (11) to perform the remediation if not possible.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for isolating anomalous hosts in a network, the network including at least two interconnected hosts, the method comprising:
segregating the hosts within the network;
detecting anomalous network traffic;
identifying an anomalous host originating the anomalous network traffic;
segregating the anomalous host to a separate network

2. The method of claim 1, wherein one of the at least two networks is a quarantine network, the quarantine network being the separate network.

3. A method for identifying noncompliant hosts in a network comprising:
monitoring hosts within the network;
identifying an attribute of a host that causes the host to be a non-compliant host; and
segregating the non-compliant host to a separate network.

4. The method of claim 3, wherein the attribute is a software version.

5. The method of claim 3, wherein the attribute is a virus.

6. The method of claim 2, wherein the attribute is spyware or other malicious software.

7. The method of claim 3, wherein the network includes a network security device which communicates with a network access device and moves the non-compliant host to the separate network.

8. The method of claim 3, wherein the network includes a network security device which spoofs replies to the non-compliant host destined for other hosts.

9. The method of claim 3, wherein the network includes a network security device which connects to the non-compliant host to reconfigure the non-compliant host into compliance.

10. A method for isolating and remediating anomalous hosts in a network, the network having at least two hosts interconnected by a network device, the network having at least two segregated networks, a working network and an isolated quarantine network, the method comprising:
detecting anomalous network traffic;
identifying the host originating the anomalous network traffic as an anomalous host;
instructing the network device used by the anomalous host for communication to divert the anomalous network traffic to the quarantine network;
diverting network traffic addressed from the anomalous host to the quarantine network;
remediating the anomalous host; and
after the remediating, placing the he remediated anomalous host is back into the network.

11. A network system, comprising:
at least two segregated hosts interconnected through a network device;
a working network;
an isolated quarantine network;
a device on the network for detecting anomalous network traffic and identifying an anomalous host that is associated with the anomalous network traffic; and
wherein the isolated quarantine network receives the anomalous network traffic.

12. The network system of claim 11 wherein the network device would either passively or actively detect anomalous network traffic using signatures.

13. The network system of claim 11 wherein the network device would either passively or actively detect anomalous network traffic using behavioral detection.
